(19) United States
(12) Patent Application Publication
(10) Pub. No.: US 2017/0087789 A1
(43) Pub. Date: Mar. 30, 2017

(54) METHOD OF OPERATING A ROTARY TABLET PRESS AND ROTARY TABLET PRESS

(71) Applicant: Fette Compacting GmbH, Schwarzenbek (DE)

(72) Inventors: Schmidt Ingo, Schwarzenbek (DE); Ozcoban Huseyin, Hamburg (DE); Heinrich Thomas, Stelle (DE)

(21) Appl. No.: 15/281,623

(22) Filed: Sep. 30, 2016

(30) Foreign Application Priority Data
Sep. 30, 2015 (DE) 102015116565.1

(51) Int. Cl. B30B 11/00; B30B 15/30; B30B 15/32; B30B 11/08

(52) U.S. Cl. CPC B30B 11/005; B30B 11/08; B30B 15/302; B30B 15/32

(57) ABSTRACT

The invention relates to a rotary tablet press and method of operation. The rotary tablet press includes a rotor that is rotatably driven that is coupled to a die plate with holes. Upper and lower punches are assigned to the holes and rotate synchronously with the die plate. A pressing apparatus presses the punches into the holes to press the filling material added to the holes. An ejector apparatus ejects the tablets pressed into the holes. A control apparatus automatically changes the rotary speed of one or more components in response to changes to components of the rotary tablet press and process components upstream or downstream of the rotary tablet press.

This application is based upon and claims priority to German Patent Application No. 10 2015 116 565.1, filed Sep. 30, 2015, under relevant sections of 35 USC §119, the entire contents of which are hereby incorporated by reference.

### BACKGROUND OF THE INVENTION

The invention relates to a method for operating a rotary tablet press comprising a rotor that is rotatably driven at a rotor rotary speed and has a die plate with holes. Upper and lower punches are assigned to the holes and rotate synchronously with the die plate. The axial movement of the upper and lower punches is controlled by upper and lower control elements. The rotary tablet press further includes a filling station with a filling apparatus for filling the holes with filling material. A pressing station is downstream of the filling station in the rotational direction of the rotor with a pressing apparatus which presses the upper and/or lower punches into the holes when passing through the pressing station in order to press the filling material added to the holes. An ejector station is downstream of the pressing station in the rotational direction of the rotor with an ejector apparatus for ejecting the tablets pressed into the holes. The filling apparatus has a filling chamber which is supplied with filling material by means of a supply opening and possesses a filling opening aligned with the holes in the die plate, wherein a filling wheel that is rotatably driven at a filling wheel rotary speed is arranged in the filling chamber. The filling wheel has a plurality of agitator blades arranged on the perimeter that pass over the filling opening during a rotation of the filling wheel. Moreover, the invention relates to a rotary tablet press.

A rotary tablet press normally contains a rotatably driven rotor with upper and lower punches that, during the rotation of the rotor, interact with holes in a die plate to press filling material located therein. After pressing, the tablets are generally ejected out of the holes by the lower punch and, for example, are scraped off of the die plate by a scraper and supplied to a tablet discharge for further processing. Various filling apparatuses such as agitator blade filling apparatuses are known for filling the holes with the filling material to be pressed. These apparatuses possess a rotatably driven filling wheel in a filling chamber filled with the filling material. The filling wheel has a plurality of agitator blades arranged on the perimeter that pass over a filling opening assigned to the holes of the die plate rotating along below the filling apparatus during a rotation of the filling wheel. On the one hand, the agitator blades of the filling wheel ensure mixing of the filling material in the filling chamber and, on the other hand, they ensure optimum filling of the holes with filling material. A rotary tablet press with such a filling apparatus is known for example from DE 10 2007 057 789 B3.

The filling wheel is rotated by a rotary drive at a filling wheel rotary speed. Like the rotor rotary speed, this is generally adjusted during a setup phase of the rotary tablet press. The setting parameters for the filling wheel rotary speed and the rotor rotary speed which depends thereupon are maintained over the entire duration of production. During operation of a rotary tablet press, it may, however, be necessary to change the rotor rotary speed. This holds true for example when a state changes of process components upstream or downstream from the rotary tablet press. Due to the change in the rotor rotary speed, the ratio changes between the rotor rotary speed and filling wheel rotary speed. This can disadvantageously affect the machine performance and tablet quality. In order to counteract this, the filling wheel rotary speed must be adapted to the changed rotor rotary speed in a manually involved manner that interrupts production.

### BRIEF SUMMARY OF THE INVENTION

On the basis of the explained prior art, the object of the invention is to provide a method and a rotary tablet press of the aforementioned type with which the production quality and tablet quality can be easily ensured, even when the rotor rotary speed changes.

For a method of the aforementioned type, the invention achieves the object in that, when the rotor rotary speed changes, the filling wheel rotary speed is automatically changed according to a previously-saved adaptation instruction during operation of the rotary tablet press, and/or when the filling wheel rotary speed changes, the rotor rotary speed is also automatically changed according to a previously-saved adaptation instruction during operation of the rotary tablet press.

The invention, furthermore, achieves the object with a rotary tablet press comprising a rotor that is rotatably driven at a rotor rotary speed and has a die plate with holes and upper and lower punches that are assigned to the holes and rotate synchronously with the die plate. Axial movement of the upper and lower punches is controlled by upper and lower control elements. The rotary tablet press also includes a filling station with a filling apparatus for filling the holes with filling material and a pressing station downstream of the filling station in the rotational direction of the rotor with a pressing apparatus which presses the upper and/or lower punches into the holes when passing through the pressing station in order to press the filling material added to the holes. An ejector station is positioned downstream of the pressing station in the rotational direction of the rotor with an ejector apparatus for ejecting the tablets pressed into the holes. The filling apparatus has a filling chamber which is supplied with filling material by means of a supply opening and possesses a filling opening aligned with the holes in the die plate. A filling wheel is rotatably driven at a filling wheel rotary speed is arranged in the filling chamber and has a plurality of agitator blades arranged on the perimeter that pass over the filling opening during rotation of the filling wheel. At least one adaptation instruction is saved in a control apparatus for operating the rotary tablet press, wherein the control apparatus also automatically changes the filling wheel rotary speed according to one of the saved adaptation instructions when the rotor rotary speed changes, and/or wherein the control apparatus also automatically changes the rotor rotary speed according to one of the saved adaptation instructions when the filling wheel rotary speed changes.

The rotary tablet press can also be a multiple rotary press, in particular a double rotary press. A plurality, in particular two, filling stations, pressing stations and ejector stations are then provided.

The rotor of the rotary tablet press possesses a rotary drive that rotatably drives the rotor, in particular, the die plate with the upper and lower punches, for example, by means of a drive shaft at the rotor rotary speed. The filling apparatus also possesses a rotary drive which drives the filling wheel for example by a drive shaft at the filling wheel rotary speed. The rotary drive of the rotor and the rotary drive of the filling apparatus are independent of each other. As mentioned at the onset, the filling apparatus has a filling chamber which is supplied, for example, powdered filling material through a supply opening. The filling wheel is rotatably arranged in the filling chamber and has a plurality of agitator blades on its perimeter. The rotary drive of the filling apparatus rotates the filling wheel so that the agitator blades rotate in the filling chamber. In so doing, they pass over a filling opening that is aligned with the holes in the die plate rotating along under the filling chamber. The filling material is added to the holes in the die plate through the filling opening. On the one hand, the agitator blades ensure thorough mixing of the filling material in the filling chamber and, on the other hand, they also ensure optimum filling of the holes in the die plate. Between the filling wheel and a top wall of the filling chamber, a distance can be provided to form a flow channel section. The supply opening can be arranged at a distance above the filling wheel. Furthermore, the filling opening in the floor of the filling chamber can be extended into an arc-shaped channel. This arc-shaped channel can be aligned with the divided circle of the holes of the die plate and extend beyond the filling chamber opposite the direction of rotation of the die plate and form a pre-filling channel outside of the filling chamber. The agitator blades can be formed like fingers and extend nearly up to, for example, the circular sidewall of the filling chamber. Of course, the filling chamber can also possess a plurality of supply openings and/or a plurality of filling openings.

The die plate of the rotary tablet press according to the invention can be designed as a single piece, or be constructed of a plurality of ring segments. The upper and lower punches can interact directly with the holes of the die plate. It is, however, also possible for the holes to be formed by releasably held die bushings in the die plate.

Based on the aforementioned realization that a change in the rotor rotary speed, while the filling wheel rotary speed remains the same, can impair machine performance and tablet quality, an automatic adaptation of the filling wheel rotary speed upon a change in the rotor rotary speed, and/or vice versa, is provided according to the invention. For this purpose, at least one adaptation instruction is saved in the control apparatus beforehand according to which the automatic adaptation of the filling wheel rotary speed occurs when there is a change in the rotor rotary speed, or respectively the automatic adaptation of the rotor rotary speed occurs when there is a change in the filling wheel rotary speed. The automatic adaptation according to the invention of the filling wheel rotary speed, or respectively the rotor rotary speed, occurs in particular substantially at the same time as the change in the rotor rotary speed, or respectively the filling wheel rotary speed. If a change is made to the rotor rotary speed that is triggered manually by an operator or controlled (automatically) by a control apparatus of the rotary tablet press, the filling wheel rotary speed is adapted basically at the same time according to the invention as per the adaptation instruction. Accordingly, optimum production quality and consistent tablet quality can be easily ensured, even upon a change in the rotor rotary speed, or respectively a change in the filling wheel rotary speed, without impairing production efficiency, for example, from an interruption in production. The underlying regularity of the adaptation instruction takes into account an optimum ratio between the rotary speeds of the rotor and the filling wheel to guarantee optimum tablet quality. The adaptation instruction can be saved in the form of a mathematical function, a characteristic, or a matrix of key figures in a control apparatus for operating the rotary tablet press.

It is noted that the filling apparatus used in the method according to the invention, or respectively in the rotary tablet press according to the invention, can possess a plurality of chambers. The additional chambers can, for example, be apportioning chambers and/or dosing chambers. In the following, and for reasons of simplicity, filling chambers will be referenced even with regard to these chambers. It is then furthermore possible to provide a wheel rotatably driven at a wheel rotary speed in more than one filling chamber, in particular in all filling chambers. Again for reasons of simplicity, filling wheels will be referenced with regard to all of these wheels. It is possible to rotatably drive all of the filling wheels at the same filling wheel rotary speed. It is, however, also possible for the filling wheel rotary speeds of some or all the filling wheels to differ from each other. It is then possible to also adapt the filling wheel rotary speeds of the other filling wheels of the filling apparatus in the manner according to the invention according to the adaptation instruction.

Different adaptation instructions can also be saved beforehand for different filling materials to be pressed in the rotary tablet press. In this case, the adaptation instruction is determined beforehand for the filling material to be used. For example, depending on the filling material being used, the control apparatus of the rotary tablet press then independently selects the appropriate adaptation instruction, in particular automatically as well.

One possible reason for a change in the rotor rotary speed or the filling wheel rotary speed can be state changes in the process components coupled to the rotary tablet press. Accordingly, it can be provided for a change in the rotor rotary speed and/or the filling wheel rotary speed to occur automatically upon a state change of process components connected to the rotary tablet press. Within the production sequence, the process components can be located before or after the rotary tablet press. Examples of process components upstream from the rotary tablet press are a mixing apparatus, a granulation apparatus, or a drying apparatus for the filling material. Examples of process components downstream from the rotary tablet press are a packaging machine for the produced tablets, or a tablet coater. The cited process components can be part of the rotary tablet press according to the invention.

The upper and lower control elements of the rotary tablet press can be upper and lower control cam elements. Furthermore, the pressing apparatus can comprise a pre-pressing apparatus and a main pressing apparatus. The pressing apparatus can also comprise at least one upper pressing roller and at least one lower pressing roller. When there is a pre-pressing apparatus and a main pressing apparatus, an upper pre-pressing roller and a lower pre-pressing roller as well as an upper main pressing roller and a lower main pressing roller can accordingly be provided.

The ejector apparatus can comprise a scraper that is arranged stationarily above the die plate and which guides the tablets to a tablet discharge.

The method according to the invention can be performed by a rotary tablet press according to the invention. Accordingly, the rotary tablet press according to the invention can be designed in particular to perform the method according to the invention.

### BRIEF DESCRIPTION OF THE DRAWING

FIG. 1 shows a schematic view of a rotary tablet press according to the invention with a flattened depiction of the rotor.

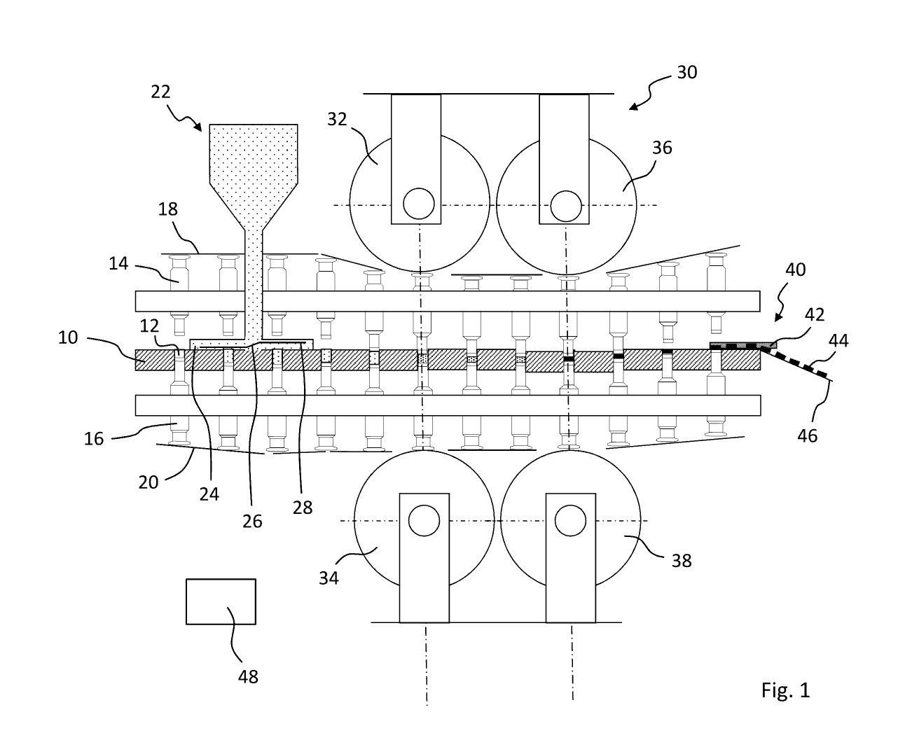

### DETAILED DESCRIPTION OF THE INVENTION

The rotary tablet press comprises a rotor rotatably driven by a rotary drive (not shown) at a rotor rotary speed with a die plate 10 which has a plurality of holes 12. Furthermore, the rotor comprises a plurality of upper punches 14 and lower punches 16 that rotate synchronously with the die plate 10. One pair consisting of an upper punch 14 and lower punch 16 is assigned to a hole 12. The axial movement of the upper punch 14 and lower punch 16 during the rotation of the rotor is controlled by upper control cam elements 18 and lower control cam elements 20. The rotary tablet press further comprises a filling station 22 with a filling apparatus which has a filling chamber 24 in which a filling wheel 26 is arranged with a plurality of agitator blades 28 arranged on the perimeter. The filling wheel 26 is driven by a rotary drive (not shown) at a filling wheel rotary speed. Moreover, the rotary tablet press comprises a pressing station 30. The pressing station 30 possesses a pre-pressing apparatus with an upper pre-pressing roller 32 and a lower pre-pressing roller 34, as well as a main pressing apparatus with an upper main pressing roller 36 and a lower main pressing roller 38. Furthermore, the rotary tablet press comprises an ejector station 40, in the present case with a scraper 42 which supplies the tablets 44 produced in the rotary tablet press to a tablet discharge 46 for further processing.

A control apparatus for operating the rotary tablet press is shown with reference number 48. The control apparatus 48 is connected by lines (not shown) to, inter alia, the rotary drive of the rotor and the rotary drive of the filling wheel 26. In an embodiment of the control apparatus 48, a plurality of adaptation instructions are saved for different filling materials to be used in the rotary tablet press for adapting the filling wheel rotary speed upon a change in the rotor rotary speed.

During operation of the rotary tablet press, the rotor is rotatably driven at a rotor rotary speed set by the control apparatus 48. At the same time, the filling wheel 26 is rotatably driven at a filling wheel rotary speed controlled by the control apparatus 48. During the rotation of the die plate 10, the holes 12 run below a filling opening of the filling chamber 24. The filling material to be pressed is added to the holes 12 through this filling opening. The filling height is specified by the lower punch 16 which partially enters the holes 12. In the region of the pressing station 30, the filling material located in the holes 12 is pressed by the upper punch 14 and lower punch 16, i.e., successively by the pre-pressing rollers 32, 34 and main pressing rollers 36, 38. After pressing the filling material, the upper punches 14 are withdrawn from the holes 12, and the produced tablets 44 are ejected by the lower punches 16 onto the top side of the die plate 10 such that they are scraped off of the top side of the die plate 10 by the scraper 42 and supplied to the tablet discharge 46 for further processing.

Other process components can be upstream and/or downstream from the rotary tablet press. As mentioned at the onset, the process components upstream from the rotary tablet press can, for example, be mixing apparatuses, granulation apparatuses or drying apparatuses. As also mentioned at the onset, the process components downstream from the rotary tablet press can, for example, be packaging machines or tablet coaters.

If, for example, a state change occurs in process components connected to the rotary tablet press, the rotor rotary speed is changed by the control apparatus 48, in particular automatically. At the same time, the control apparatus 48 automatically adapts to the filling wheel rotary speed corresponding to the adaptation instruction appropriate for the filling material used. This, therefore, ensures that even in the event of a change in the rotor rotary speed which may be necessary, optimum production quality is ensured at all times, and without interrupting production.

1. A method for operating a rotary tablet press, the method comprising:
driving a rotor at a rotor rotary speed, the rotor including a die plate with holes;
rotating upper and lower punches synchronously with the die plate, the upper and lower punches being assigned to the holes;
moving the upper and lower punches in an axial direction with respect to the holes by upper and lower control elements;
filling the holes with filling material dispensed from a filling apparatus;
agitating the filling material with a filling wheel, the filling wheel having a filling wheel rotary speed and agitator blades arranges around a perimeter of the filling wheel;
pressing at least one of the upper and lower punches into the holes in order to press the filling material added to the holes;
ejecting tablets pressed into the holes; and
automatically changing the filling wheel rotary speed according to at least one stored adaptation instruction in response to a change in the rotor rotary speed during operation of the rotary tablet press, and automatically changing the rotor rotary speed according to at least one stored adaptation instruction in response to a change in the filling wheel rotary speed during operation of the rotary tablet press.

2. The method according to claim 1, wherein the at least one stored adaptation instruction is saved in a form of a mathematical function, a characteristic, or a matrix of key figures in a control apparatus.

3. The method according to claim 1, wherein different adaptation instructions are saved for different filling materials to be pressed in the rotary tablet press.

4. The method according to claim 1, wherein a change in at least one of the rotor rotary speed and the filling wheel rotary speed occurs automatically upon a state change of process components connected to the rotary tablet press.

5. A rotary tablet press comprising:
a rotor configured to be rotatably driven at a rotor rotary speed;
a die plate with holes, the die plate coupled to the rotor;
upper and lower punches that are assigned to the holes and configured to rotate synchronously with the die plate;
upper and lower control elements configured to control axial movement of the upper and lower punches;
a filling station with a filling apparatus for filling the holes with filling material, the filling apparatus further comprising,
a filling chamber,
a filling wheel positioned in the filling chamber and configured to be rotatably driven at a filling wheel rotary speed, the filling wheel including a plurality of agitator blades arranged around a perimeter of the filling wheel;
a supply opening configured to connect to the filling chamber, and
a filling opening configured to align with one or more of the holes,
a pressing station positioned downstream of the filling station, the pressing station including a pressing apparatus configured to press at least one of the upper and lower punches into the hole when passing through the pressing station in order to press the filling material added to the hole, and wherein the agitator blades are configured to pass over the filling opening during rotation of the filling wheel;
an ejector station positioned downstream of the pressing station, the ejector station including an ejector apparatus for ejecting tablets pressed into the holes; and
a control apparatus configured to store at least one adaptation instruction for operating the rotary tablet press, and wherein the control apparatus is configured to automatically change the filling wheel rotary speed according to the at least one adaptation instruction when the rotor rotary speed changes, and wherein the control apparatus is configured to automatically change the rotor rotary speed according to the at least one adaptation instruction when the filling wheel rotary speed changes.

6. The rotary tablet press according to claim 5, wherein the at least one adaptation instruction is saved in a form of a mathematical function, a characteristic, or a matrix of key figures in the control apparatus.

7. The rotary tablet press according to claim 5, wherein different adaptation instructions are saved in the control apparatus which correspond to different filling materials to be pressed in the rotary tablet press.

8. The rotary tablet press according to claim 5, wherein the control apparatus is configured to automatically change at least one of the rotor rotary speed or the filling wheel rotary speed upon a state change of at least one process component connected to the rotary tablet press.

9. The rotary tablet press according to claim 5, wherein the upper and lower control elements are upper and lower control cam elements.

10. The rotary tablet press according to claim 5, wherein the pressing apparatus comprises a pre-pressing apparatus and a main pressing apparatus.

11. The rotary tablet press according to claim 5, wherein the pressing apparatus comprises at least one upper pressing roller and at least one lower pressing roller.

12. The rotary tablet press according to claim 5, wherein the ejector apparatus comprises a scraper that is arranged stationarily above the die plate and is configured to guide the tablets to a tablet discharge.
